(19) United States
(12) Patent Application Publication
(10) Pub. No.: US 2006/0089729 A1
(43) Pub. Date: Apr. 27, 2006

(54) Safety and power saving device for a kitchen ventilator

(76) Inventor: Yuan-Fu Chang, Fong Yuan City (TW)

Correspondence Address: CHARLES E. BAXLEY, ESQ., 90 JOHN STREET, THIRD FLOOR, NEW YORK, NY, 10038, US

(21) Appl. No.: 10/974,407

(22) Filed: Oct. 27, 2004

(51) Int. Cl. G05B 11/01; G05B 9/02

(52) U.S. Cl. 700/21; 700/79; 700/82

(57) ABSTRACT

The present invention relates to a safety and power-saving device for a kitchen ventilator comprising: a setup unit employed to send out a signal for controlling the operating time of the ventilator; a CPU serving to receive the signal from the setup unit and send out a display signal, a delay signal and a control signal; a display unit serving to receive the display signal from the CPU and to display the operating time of the kitchen ventilator; a delay unit serving to receive the delay signal and to enable the kitchen ventilator to continue operating for a longer period of time after the operating time expires; a control unit serving to receive the control signal and to turn off the cooking appliance after the operating time expires.

### BACKGROUND OF THE INVENTION

1. Field of the Invention

The present invention relates to a safety and power-saving device, and more particularly to a safety and power-saving device for a kitchen ventilator.

2. Description of the Prior Arts

The kitchen ventilator is used to exhaust the oil smoke out of the kitchen, and the working efficiency of the ventilator is determined by many factors: such as the operating manner, the installation position and the power of the ventilator. Besides the above-mentioned factors, the power-consumption and the safety are the important factors that should be taken into consideration, because the following problems are likely to be caused when the conventional kitchen ventilator is being used:

First, the kitchen ventilator is normally used to exhaust the oil smoke produced by the gas cookers thereunder, however, once the cooking is finished, the kitchen ventilator can not be turned off automatically, so the power will be wasted.

Second, sometimes, some foods need to be cooked for a long period of time, and the user is likely to leave the kitchen to do other things, leaving the foods cooking on the stove. If the user forgets to turn the kitchen ventilator and the gas cooker off after the foods are fully cooked, the power and the gas will be dissipated, the food will be overcooked or burnt, and even worse, the kitchen possibly catches fire.

The present invention has arisen to mitigate and/or obviate the afore-described disadvantages.

### SUMMARY OF THE INVENTION

The primary objective of the present invention is to provide a safety and power-saving device for a kitchen ventilator capable of setting the operating time of the kitchen ventilator and turning off the cooking appliance automatically after the operating time expires. Thereby, the electric power can be saved.

The secondary objective of the present invention is to provide a safety and power-saving device for a kitchen ventilator, the safety and power-saving device is able to set the operating time of a ventilator, and after the cooking appliance is turned off, the kitchen ventilator will continue working for a longer period of time, thus, the oil smoke can be completely exhausted out of the kitchen.

A safety and power-saving device for a kitchen ventilator in accordance with the present invention comprises:

a setup unit employed to send out a signal for controlling the operating time of the ventilator;

a central processing unit (CPU) serving to receive the signal from the setup unit and then to send out a display signal, a delay signal and a control signal;

a display unit serving to receive the display signal from the CPU and to display the operating time of the kitchen ventilator;

a delay unit serving to receive the delay signal from the CPU, and serving to enable the kitchen ventilator to continue operating for a longer period of time after the operating time expires;

a control unit serving to receive the control signal from the CPU, and serving to turn off the cooking appliance after the operating time expires.

The present invention will become more obvious from the following description when taken in connection with the accompanying drawings, which show, for purpose of illustrations only, the preferred embodiments in accordance with the present invention.

### BRIEF DESCRIPTION OF THE DRAWINGS

FIG. 1 is a block chart for showing a safety and power-saving device for a kitchen ventilator in accordance with a first embodiment of the present invention;

FIG. 2 is a block chart for showing a safety and power-saving device for a kitchen ventilator in accordance with a second embodiment of the present invention.

### DETAILED DESCRIPTION OF THE PREFERRED EMBODIMENTS

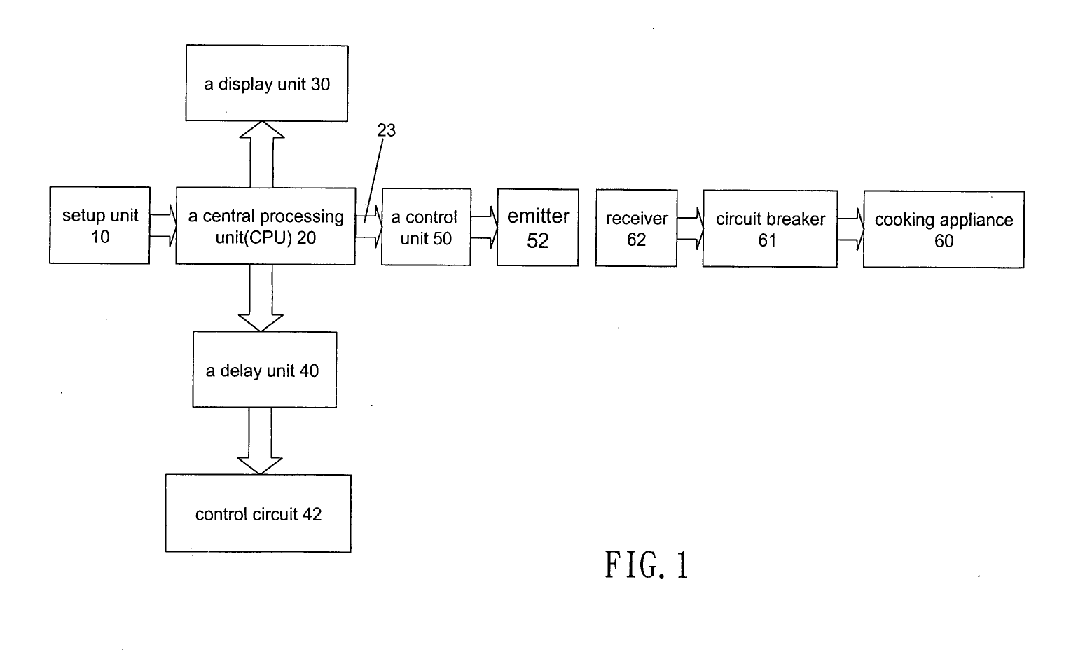

Referring to FIG. 1, a safety and power-saving device for a kitchen ventilator in accordance with a first embodiment of the present invention generally comprises: a setup unit 10, a central processing unit (CPU) 20, a display unit 30, a delay unit 40 and a control unit 50.

The setup unit 10 is to be pressed by the user so as to send out a signal 11 for controlling the operating time of the ventilator.

The CPU 20 serves to receive the signal 11 from the setup unit 10 and then to send out a display signal 21, a delay signal 22 and a control signal 23.

The display unit 30 serves to receive the display signal 21 from the CPU 20 and to display the operating time of the kitchen ventilator.

The delay unit 40 receives the delay signal 22 from the CPU 20, and after the operating time is up, the delay unit 40 will send a drive signal 41 to a control circuit 42 for enabling the motor of the kitchen ventilator to continue operating for a longer period of time, and then to turn the motor off after the delayed-off time expires.

The control unit 50 is controlled by the control signal 23 of the CPU 20 and serves to turn off the cooking appliance 60 after the operating time of the kitchen ventilator expires. The cooking appliance 60 can be a gas cooker, an electric stove, and etc. The control unit 50 is connected with an end of control line 51, the cooking appliance 60 is provided with a circuit breaker 61 which is connected to another end of the control line 51. The control unit 50 will employ the circuit breaker 61 to turn off the cooking appliance 60 after the operating time of the kitchen ventilator expires.

After setting the operating time of the kitchen ventilator by pressing the setup unit 10, the user can leave the kitchen to do other things. And then, through the control line 51, the control unit 50 will employ the circuit breaker 61 to turn off the cooking appliance 60 after the operating time of the kitchen ventilator expires. Meanwhile, the delay unit 40 employs the control circuit 42 to enable the kitchen ventilator to continue working for a longer period of time. Thus, the oil smoke will be completely exhausted out of the kitchen. Furthermore, since the operating time of the kitchen ventilator can be set according to needs, and the cooking appliance 60 will be turned off after the operating time of the kitchen ventilator expires, the power is accordingly saved.

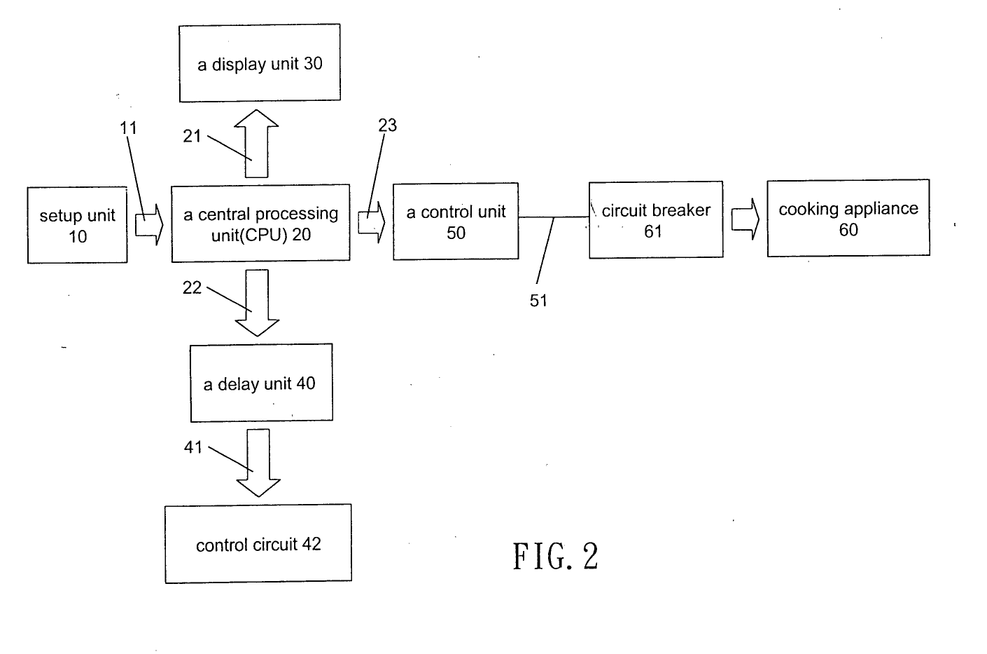

Referring to FIG. 2, a safety and power-saving device for a kitchen ventilator in accordance with a second embodiment of the present invention also comprises: a setup unit 10, a CPU 20, a display unit 30, a delay unit 40 and a control unit 50. However, the second embodiment is kind of different from the first embodiment, and the differences are explained as follows:

The control unit 50 is connected to an emitter 52, while the cooking appliance 60 is provided with a circuit breaker 61 which is connected to a receiver 62. The control unit 50 receives the control signal 23 from the CPU 20, and after the operating time of the kitchen ventilator expires, the control unit 50 will send a signal to the receiver 62 by using the emitter 52, so as to enable the circuit breaker 61 to turn off the cooking appliance 60. Meanwhile, the delay unit 40 employs the control unit 42 to enable the kitchen ventilator to continue working for a longer period of time. Thus, the oil smoke will be completely exhausted out of the kitchen. Furthermore, since the operating time of the kitchen ventilator can be set according to needs, and the cooking appliance 60 will be turned off after the operating time of the kitchen ventilator expires, the power can be accordingly saved.

While we have shown and described various embodiments in accordance with the present invention, it should be clear to those skilled in the art that further embodiments may be made without departing from the scope of the present invention.

What is claimed is:

1. A safety and power-saving device for a kitchen ventilator comprising:
a setup unit employed to send out a signal for controlling the operating time of the ventilator;
a central processing unit (CPU) serving to receive the signal from the setup unit and then to send out a display signal, a delay signal and a control signal;
a display unit serving to receive the display signal from the CPU and to display the operating time of the kitchen ventilator;
a delay unit serving to receive the delay signal from the CPU, and serving to enable the kitchen ventilator to continue operating for a longer period of time after the operating time expires;
a control unit serving to receive the control signal from the CPU, and serving to turn off the cooking appliance after the operating time expires.

2. The safety and power-saving device for a kitchen ventilator as claimed in claim 1, wherein the delay unit sends out a drive signal to a control circuit for turning the kitchen ventilator off after operating for the longer period of time.

3. The safety and power-saving device for a kitchen ventilator as claimed in claim 1, wherein the control unit is connected with an end of a control line, the cooking appliance is provided with a circuit breaker which is connected to another end of the control line, the control unit employs the circuit breaker to turn off the cooking appliance after the operating time of the kitchen ventilator expires.

4. The safety and power-saving device for a kitchen ventilator as claimed in claim 1, wherein the control unit is connected to an emitter, the cooking appliance is provided with a circuit breaker which is connected to a receiver, the control unit sends a signal to the receiver by employing the emitter, so as to enable the circuit breaker to turn off the cooking appliance.

5. The safety and power-saving device for a kitchen ventilator as claimed in claim 1, wherein the cooking appliance is a gas cooker.

6. The safety and power-saving device for a kitchen ventilator as claimed in claim 2, wherein the cooking appliance is a gas cooker.

7. The safety and power-saving device for a kitchen ventilator as claimed in claim 3, wherein the cooking appliance is a gas cooker.

8. The safety and power-saving device for a kitchen ventilator as claimed in claim 4, wherein the cooking appliance is a gas cooker.

9. The safety and power-saving device for a kitchen ventilator as claimed in claim 1, wherein the cooking appliance is an electric stove.

10. The safety and power-saving device for a kitchen ventilator as claimed in claim 2, wherein the cooking appliance is an electric stove.

11. The safety and power-saving device for a kitchen ventilator as claimed in claim 3, wherein the cooking appliance is an electric stove.

12. The safety and power-saving device for a kitchen ventilator as claimed in claim 4, wherein the cooking appliance is an electric stove.
